(19) United States
(12) Patent Application Publication
(10) Pub. No.: US 2007/0248402 A1
(43) Pub. Date: Oct. 25, 2007

(54) DISCHARGING HEAD OF A TEETH-WHITENING BRUSH

(76) Inventor: Li-Chun CHAN, Taichung City (TW)

Correspondence Address: LEONG C LEI, PMB # 1008, 1867 YGNACIO VALLEY ROAD, WALNUT CREEK, CA, 94598, US

(21) Appl. No.: 11/379,808

(22) Filed: Apr. 24, 2006

(51) Int. Cl. A47L 13/22; B43K 5/06

(52) U.S. Cl. 401/286; 401/277; 401/174

(57) ABSTRACT

A suspension head of a teeth-whitening brush. The discharging head comprises a discharging tube having a shape corresponding to that of the discharging hole edge of a brush cover. The top end of the storing tube of the teeth-whitening brush is provided with an insertion hole at a discharging end for the connection with a plastic discharging tube. The bottom section of the teeth-whitening brush is an insertion seat which is mounted to the discharging end of the tube seat. The external of the discharging tube is a bristle rim and is inserted into the conic shaped hole of the brush cover such that the bristle is protruded out with an appropriate length. The discharging tube is aligned with the hole edge of the brush cover so that the discharging structure has an interior and exterior rim hole, which are symmetrical, allowing evenly discharging of a coating.

### BACKGROUND OF THE INVENTION

(a) Technical Field of the Invention

The present invention relates to teeth-whitening brush, and in particular, a discharging head of a teeth-whitening brush. The discharging head allows evenly discharging of material from the brush.

(b) Description of the Prior Art

FIGS. 5 and 6 show a conventional teeth-whitening brush having a storing tube 30 containing make-up material such as teeth-whitening cream, eye-shadow, lipstick cream, etc. The bottom of the brush is a squeezing valve plate 31 and in combination with a rotating screw rod 34 and a securing screw nut 33 for mounting a rotating seat 32 at the bottom thereof. The rotation of the rotating seat 32 will cause the screw rod 34 to move upward so that the cosmetic or make-up material is squeezed out from the valve plate 31. The opening at the top end of the storing tube 30 is a protruded tubing seat 35 and the center of the tubing seat is a circular hole 36 for the insertion of a discharging tube 37 so as to lead make-up material. The discharging tube is stainless steel as it touches human skin, and therefore, the cost of the tube is high. Due to the large diameter of the tube the cost of manufacturing the tube is expensive, and for better handling, the tube has about a diameter of 1.2 mm, and the discharging tube 37 is small, and the flowrate is insufficient. Further, the edge of the discharging hole 39 of the brush cover 38 is oval shape, the bristles are formed as a flat structure and therefore, the flowrate of the discharge material is insufficient and occasionally, numerous times of squeezing have to be made and therefore, it is a waste of time and it is not convenient in using the brush.

### SUMMARY OF THE INVENTION

The primary purpose of the present invention is to provide a discharging head of a teeth-whitening brush having a storing tune at the upper portion of the head; a tube seat, a discharge tube, a brush cover and a bristle rim at the top end of the head; and a valve plate for bottom linkage of the tube body, screw rod and fastening nut, and a rotating seat mounted at the bottom section of the storing tube, and an insertion tube at the center of the seat body so that the screw rod can be passed through, and the rotation of the rotating seat the valve plate is controlled to move up and down to control the squeezing operation, characterized in that the center of the external end of the tube seat is an insertion slot which is linked to a conic-shaped path within the interior of the seat body for the direction connection with the insertion seat protruded from the bottom end of the discharging tube, forming into a complete discharging path, and the discharging hole has a shape similar to that at the external side covering the brush cover.

Yet it is another object of the present invention is to provide a discharging head of a teeth-whitening brush, wherein the lower section of the discharging tube is mounted with a protruded end plates for the positioning of the insertion seat and the storing tube seat, and the upper section of the plate body is used for the mounting of the bristle rim.

Still another object of the present invention is to provide a discharging head of a teeth-whitening brush, wherein the discharging tube is in aligned with the discharging hole of the brush cover.

A further object of the present invention is to provide a discharging head of a teeth-whitening brush, wherein the discharging tube is made into an oval shape similar to that of the discharging hole.

Still yet another object of the present invention is to provide a discharging head of a teeth-whitening brush, wherein the interior of the tube seat is a conic shaped path.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a teeth-whitening brush in accordance with the present invention.

FIG. 2 is a sectional view along the axial of the teeth-whitening brush in accordance with the present invention.

FIG. 3 is a perspective view of the teeth-whitening brush with the brush cap being opened, in accordance with the present invention.

FIG. 4 is a side sectional view of the teeth-whitening brush in accordance with the present invention.

FIG. 5 is a perspective exploded view of a conventional teeth-whitening brush.

FIG. 6 is a side sectional view of the conventional teeth-whitening brush.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

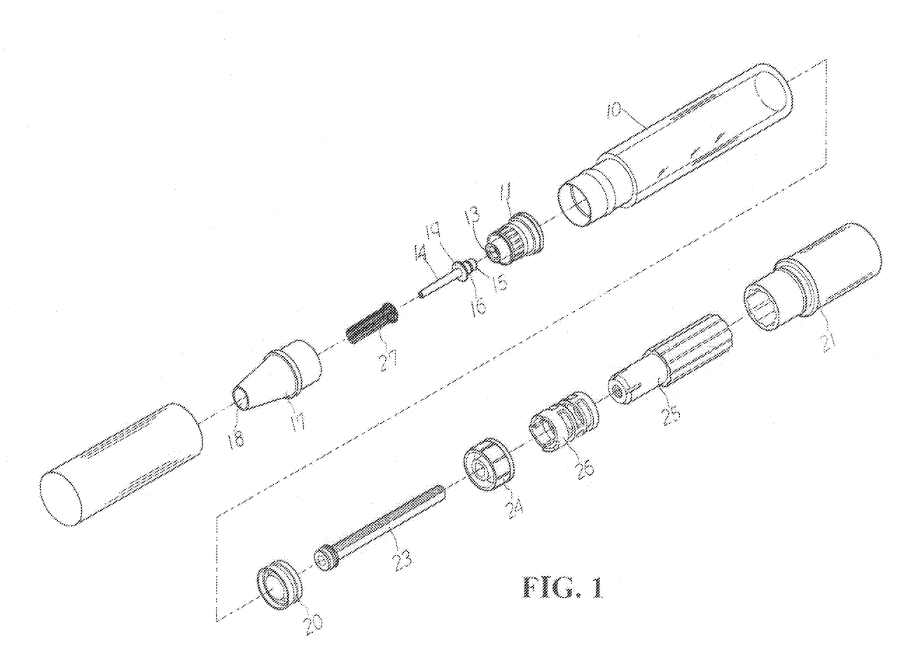

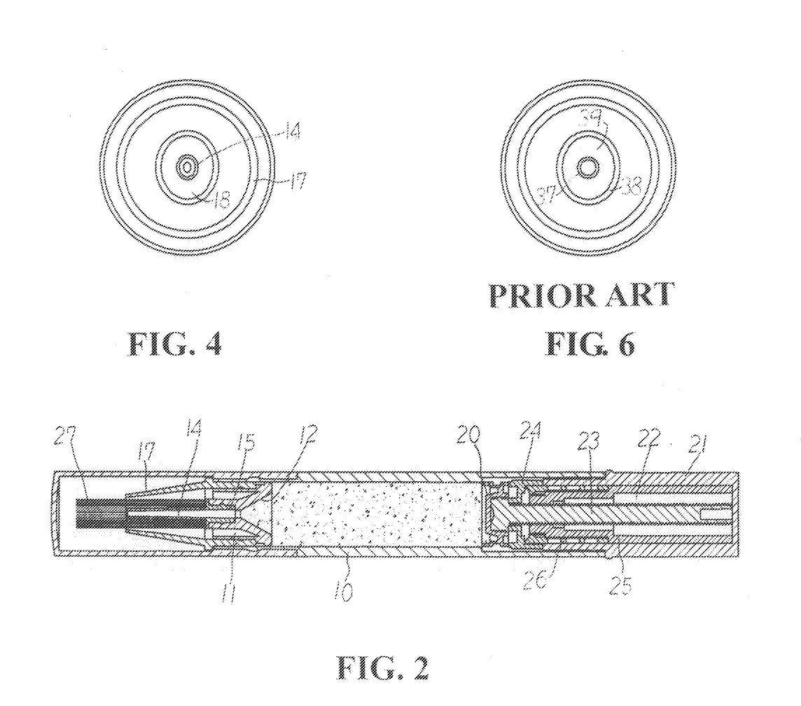

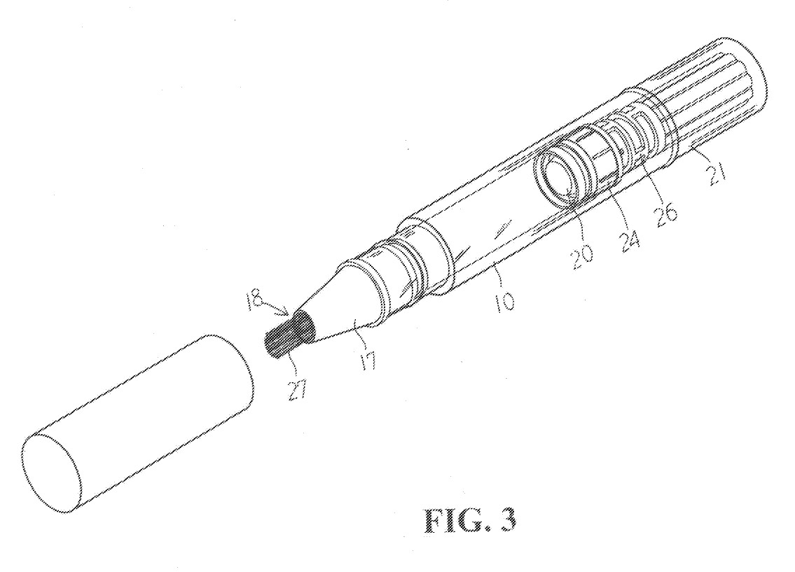

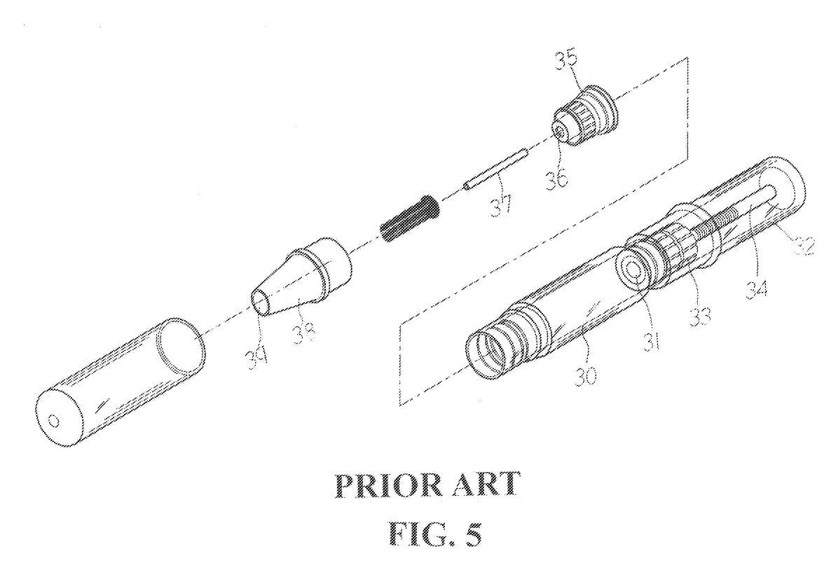

Referring to FIGS. 1 to 3, there is shown a teeth-whitening brush having a discharging head comprising an upper portion for material storage and a lower portion which is a transmission device for squeezing of material. The bottom section of a storing tube 10 is sealed by a valve in combination with a rotating seal 21 at the bottom thereof. The center of the seat body is protruded to form an insertion tube 22, and the inner edge of the tube is made into a shape corresponding to the transmission screw rod 23 such that the screw rod 23, passing through a securing screw nut 24, mounting with a transmission cover 25 for securing with an elastic member 26, is then directly mounted to the insertion tube 26 protruded from the bottom of the rotating seat 21. The external rim face of the transmission cover 25 is engaged with the inner edge face of the rotating seat 21 and the rotation of the rotating seat 21 controls the valve plate 20 to slide up and down to squeeze material. The discharging hole edge at the top section of the storing tube 10 is mounted with a tubing seat 11 having a conic shaped leading path 12, and the center of the external end of the tube path 11 is an insertion slot 13, passing through the interior of the leading path 12 to allow the discharging tube 14 having a protruded insertion seat 15 to directly engaged with the protruded edge 16 at the circular face of the seat 11, forming into a complete discharging path. The tubing hole of the discharging tube has a similar shape to the discharging hole 18 of the brush cover 17, and generally, the shape is an oval shape. The lower edge at the lower section is a protruded end plate 19 and the bottom section of the end plate 19 is the insertion seat 15 which is connected to the tubing seat 11. The top portion of the plate body is bristle rim 27 which can be easily passed through the brush cover and are with appropriate length. The discharging tube 14 is protruded to the end hole of the brush cover 17 and is aligned with the end hole, allowing the material from the brush to only touch the bristles and will not have a rigid and uncomfortable feeling which ensure comfortable and convenient application of using the brush.

The main features of the present invention are that the discharging tube 14 has a similar to the discharging hole 18 of the brush cover 17, and when the rotating screw rod 23 of the rotating seat 21 is rotated to squeeze material for make-up, the pushing of the valve plate 20 causes the make-up material to pass through the conic shape leading path 12 at the interior of the tubing seat 11 at the top section of the storing tube 10, and pass through the discharging tube 14 to the discharging hole 18. The bristles at the bristles rim 27 are used for make-up, and due to the similar shape of the discharging hole 18 with the discharging tube 14, the discharging of the make-up material shall be evenly and wide, and the oval shape of the discharging hole increase the flow rate to about 1.5 times of the conventional teeth-whitening brush, which will not cause an interruption of make-up material in the course of making up. Further, the discharging tube 14 is made from plastic material and therefore the cost of manufacturing is lower.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A discharging head of a teeth-whitening brush having a storing tube at the upper portion of the head; a tube seat, a discharge tube, a brush cover and a bristle rim at the top end of the head; and a valve plate for bottom linkage of the tube body, screw rod and fascinating nut, and a rotating seat mounted at the bottom section of the storing tube, and an insertion tube at the center of the seat body so that the screw rod can be passed through, and the rotation of the rotating seat the valve plate is controlled to move up and down to control the squeezing operation, characterized in that the center of the external end of the tube seat is an insertion slot which is linked to a conic-shaped path within the interior of the seat body for the direction connection with the insertion seat protruded from the bottom end of the discharging tube, forming into a complete discharging path, and the discharging hole has a shape similar to that at the external side covering the brush cover.

2. The discharging head of claim 1, wherein the lower section of the discharging tube is mounted with a protruded end plates for the positioning of the insertion seat and the storing tube seat, and the upper section of the plate body is used for the mounting of the bristle rim.

3. The discharging head of claim 1, wherein the discharging tube is in aligned with the discharging hole of the brush cover.

4. The discharging head of claim 1, wherein the discharging tube is made into an oval shape similar to that of the discharging hole.

5. The discharging head of claim 1, wherein the interior of the tube seat is a conic shaped path.

6. The discharging head of claim 1 or 2, wherein the bottom end of the discharging tube is protruded with an insertion seat having a rim face and the rim face is provided with a protruded edge for the positioning of an insertion module.
